(19) United States
(12) Patent Application Publication
(10) Pub. No.: US 2006/0294580 A1
(43) Pub. Date: Dec. 28, 2006

(54) Administration of access to computer resources on a network

(76) Inventor: Frank Yeh JR., Santa Ana, CA (US)

Correspondence Address: INTERNATIONAL CORP (BLF), c/o BIGGERS & OHANIAN, LLP, P.O. BOX 1469, AUSTIN, TX, 78767-1469, US

(21) Appl. No.: 11/168,690

(22) Filed: Jun. 28, 2005

(51) Int. Cl. H04L 9/32

(52) U.S. Cl. 726/3

(57) ABSTRACT

Administration of access to computer resources on a network including receiving in a network access control module on a network, from a device communicatively coupled to the network, a request for access to resources on the network, the request including computer data representing an identity of the device, an identity of a current user of the device, and a current configuration of the device; and granting, by the network access control module to the device, access to resources on the network in dependence upon the identity of the device, the identity of the current user, the current configuration of the device, and a configuration of the device authorized for the current user.

### BACKGROUND OF THE INVENTION

1. Field of the Invention

The field of the invention is data processing, or, more specifically, methods, systems, and products for administration of access to computer resources on a network.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

Computer resource requirements for business and government applications often increase over a time period due to sales or employee growth. Over the same time period, the resource requirements may fluctuate dramatically due to inevitable peaks and valleys of day to day operations or from increased loads for seasonal, period-end, or special promotions. The peak resource requirements within a time period may be very different from the valley resource requirements. In order to be effective at all times, the computerized resources of a business must be sufficient to meet the current fluctuating needs of the business as well as projected needs due to growth.

To address such fluctuating and ever increasing resource demands, a customer conventionally purchases computing resources capable of accommodating at least its current peak requirement while planning for future requirements which are likely to be elevated. Customers therefore face the prospect of investing in more computerized resources than are immediately needed in order to accommodate growth and operational peaks and valleys. At any given time, therefore, the customer may have excess computing capacity—a very real cost. Such costs can represent a major expenditure for any computer customer.

To address this problem, computing architectures support ‘capacity on demand,’ allowing customers to own more computer resources than they have paid for. When the need for resources increases, due to a temporary peak demand or to permanent growth, customers may purchase or rent additional computer resources already installed on their computers but not yet activated. Such customers may obtain authorization in the form of security codes or authorization enablement codes to activate additional resources temporarily or permanently.

Management of devices today is becoming more complex as the population of devices expands. Devices that enable users to access data and information over networks have proliferated as new technologies and access methods are introduced. Managing a device includes managing the components that make up or are installed on the device. These components can be both hardware and software. As enterprises and organizations expose more and more data over the internet, more people are accessing this data in more ways than ever, and the management of devices including their hardware and software components has become a major problem.

Current solutions provide user identity management, including providing a user all credentials needed to perform a job while excluding access to resources for which the user is not authorized—all based on customer designed policies. A user credential is the key that enables or disables access so managing user access to resources is accomplished by managing user credentials. Credentials can take the form of an account that is used by a login/password challenge authentication factor, a biometric signature used by a biometric authentication factor, a public key infrastructure (‘PKI’) certificate that can be used by Web applications, a token or smart card and any other object that can be used by an authentication or authorization factor to allow or disallow access to something based on user identity.

In addition to identity management, there currently exist a number of applications for device configuration management, management of on-demand resources, resources that a user organization may own and may or may not be authorized to use. The device configuration management solutions are able to track and manage registered devices and various configurable components of a device. These configurable components could be hardware or software or content ranging from a complete image of the device to a registry setting to a software patch or license. Device configuration management solutions attempt to ensure that a device is configured with all of the hardware and software components that it should have based on a customer-defined policy.

In current art, therefore there exists user identity and credential management and device configuration management—with, however, no coordination between the two. Current solutions that can track user identities and credentials are not integrated with solutions that can manage device components and configurations. No solutions exist today that are able to track the hardware and software profile of a device, the current configuration of the device, and the configuration of the device as authorized for a particular user. No solutions exist today that provide the capability of coordinating a device configuration with the identity of an authorized user.

### SUMMARY OF THE INVENTION

Methods, systems, and products are disclosed for administration of access to computer resources on a network that include receiving in a network access control module on a network, from a device communicatively coupled to the network, a request for access to resources on the network, the request including computer data representing an identity of the device, an identity of a current user of the device, and a current configuration of the device; and granting, by the network access control module to the device, access to resources on the network in dependence upon the identity of the device, the identity of the current user, the current configuration of the device, and a configuration of the device authorized for the current user.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram illustrating an exemplary system for administration of access to computer resources on a network according to embodiments of the present invention.

FIG. 2 sets forth a data flow diagram illustrating operation of a further exemplary system for administration of access to computer resources on a network according to embodiments of the present invention.

FIG. 3 sets forth a line drawing of exemplary data structures useful in systems for administration of access to computer resources on a network according to embodiments of the present invention.

FIG. 4 sets forth a block diagram of automated computing machinery comprising an exemplary computer useful in administration of access to computer resources on a network according to embodiments of the present invention.

FIG. 5 sets forth a flow chart illustrating an exemplary method for administration of access to computer resources on a network according to embodiments of the present invention.

FIG. 6 sets forth a flow chart illustrating an exemplary method of granting access to resources on a network according to embodiments of the present invention.

FIG. 7 sets forth a flow chart illustrating an exemplary method for reconfiguring a device to a configuration of the device authorized for a current user according to embodiments of the present invention.

FIG. 8 sets forth a flow chart illustrating a further exemplary method for administration of access to computer resources on a network according to embodiments of the present invention.

### DETAILED DESCRIPTION OF EXEMPLARY EMBODIMENTS

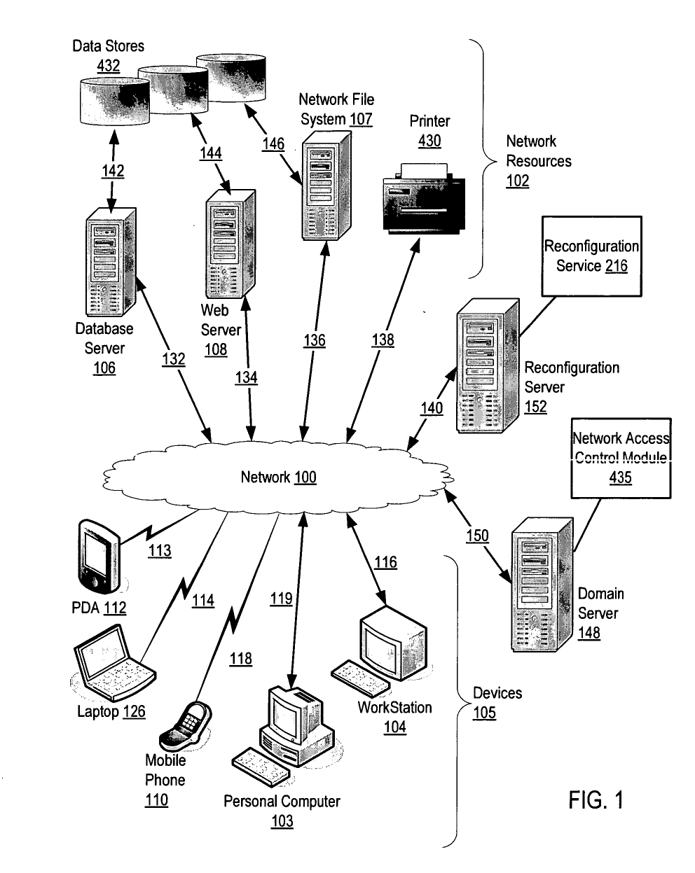

Exemplary methods, systems, and products for administration of access to computer resources on a network according to embodiments of the present invention are described with reference to the accompanying drawings, beginning with FIG. 1. FIG. 1 sets forth a network diagram illustrating an exemplary system for administration of access to computer resources on a network according to embodiments of the present invention. The system of FIG. 1 operates generally for administration of access to computer resources (102) on a network according to embodiments of the present invention by receiving in a network access control module (435) on a network (100), from a device (105) communicatively coupled to the network (100), a request for access to resources (102) on the network, the request including computer data representing an identity of the device, an identity of a current user of the device, and a current configuration of the device. The system of FIG. 1 also operates for administration of access to computer resources on a network according to embodiments of the present invention by granting, by the network access control module (435) to the device (105), access to resources (102) on the network in dependence upon the identity of the device, the identity of the current user, the current configuration of the device, and a configuration of the device authorized for the current user.

The term ‘network’ is used in this specification to mean any networked coupling for data communications among two or more computers. Network data communication typically is implemented with specialized computers called routers. Networks typically implement data communications by encapsulating computer data in messages that are then routed from one computer to another. A well known example of a network is an ‘internet,’ an interconnected system of computers that communicate with one another according to the ‘Internet Protocol’ as described in the IETF's RFC 791. Other examples of networks useful with various embodiments of the present invention include intranets, extranets, local area networks (‘LANs’), wide area networks (“WANs”), virtual private networks (‘VPNs’), and other network arrangements as will occur to those of skill in the art. Typically, a LAN is a network connecting computers and word processors and other electronic office equipment to create a communication system between offices. A virtual private network is a network constructed by using public wires to connect nodes, but containing additional security features. For example, a number of networks use the Internet as the medium for transporting data. These networks use encryption and other security mechanisms to ensure that only authorized users can access the network and that the data cannot be intercepted.

The system of FIG. 1 includes a data communications network (100) that supports data communications among devices (105) communicatively coupled to the network, network resources (102), a domain server (148), and a reconfiguration server (152). The system of FIG. 1 includes several devices (105) communicatively coupled to the network and capable of requesting access to resources on the network (100), including:
workstation (104), a computer coupled to network (100) through wireline connection (116);
personal computer (103), coupled to network (100) through wireline connection (119);
mobile phone (110), coupled to network (100) through wireless connection (118);
laptop computer (126), coupled to network (100) through wireless connection (114); and
personal digital assistant (112), coupled to network (100) through wireless connection (113).

The system of FIG. 1 also includes network resources (102). A network resource in any computer resource or device capable of being used across a network by another device communicatively coupled to the network. Examples of network resources generally include software applications, data files, computing devices, and computer peripherals communicatively coupled to a network and made available to other devices or programs running on other devices. In the example of FIG. 1, network resources are represented by printer (430), data stores (432), database server (106), web server (108), and network file system (107). Printer (430), database server (106), web server (108), and network file system (107) are coupled to network (100) through wireline connections (138, 132, 134, and 136), respectively. The data stores (432) are coupled to database server (106), web server (108), and network file system (107) respectively through wireline connections (142, 144, and 146). Thus, one of the devices (105) can access files in the data stores (432) by connecting to any of the three servers (106, 108, and 107). Networks resources may also include other servers and other resources not shown in the above diagram.

The system of FIG. 1 also includes domain server (148), a domain server on which a network access control module (435) is installed and operative. A domain server is a server that operates a network access control module to authenticate users at logon and grant appropriate permissions for use of network resources. Such a domain server typically maintains a database, often in directory form, of users with access to the network. In the example of FIG. 1, a network access control module (435) receives requests for access to network resources from devices (105) communicatively coupled to the network and processes the requests. Such requests for access to network resources typically include computer data representing an identity of a device, an identity of a current user of the device, and a current configuration of the device. Network access control module (435) grants to the device (105) access to resources (102) on the network in dependence upon the identity of the device, the identity of the current user, the current configuration of the device, and a configuration of the device authorized for the current user of the device. Network access control module (435) may be developed initially to carry out administration of access to computer resources on a network according to embodiments of the present invention. Alternatively an existing network access control solution may be improved to carry out administration of access to computer resources on a network according to embodiments of the present invention. Examples of existing network access control solutions include Cisco Systems' Network Admission Control (‘NAC’), Trusted Computing Group's Trusted Network Connect (‘TNC’), and Microsoft's Network Access Protection (‘NAP’).

The system of FIG. 1 also includes reconfiguration server (152), a server having installed upon it a reconfiguration service (216). A reconfiguration service (216) may receive a configuration of a device (105), that is, the configuration authorized for the current user of the device, and may transmit to the device (105) authorization enablement codes to configure the device as authorized for the current user in accordance with embodiments of the present invention. Reconfiguration server (152) is coupled to network (100) through wireline connection (140).

The arrangement of servers and other devices making up the exemplary system illustrated in FIG. 1 are for explanation, not for limitation. In the system of FIG. 1, the network resources (102), the domain server (148), and the devices (105) all reside on a single network. The network resources (102) and domain server (148) may, however, be connected through a LAN or a VPN or another network. The network resources (102), devices (105) communicatively coupled to the network, reconfiguration server (152) and domain server (148) useful according to various embodiments of the present invention may include additional servers, routers, other devices, and peer-to-peer architectures, not shown in FIG. 1, and may be arranged in any arrangements as will occur to those of skill in the art. Networks in such data processing systems may support many data communications protocols, including for example TCP/IP, HTTP, WAP, HDTP, and others as will occur to those of skill in the art. Various embodiments of the present invention may be implemented on a variety of hardware platforms in addition to those illustrated in FIG. 1.

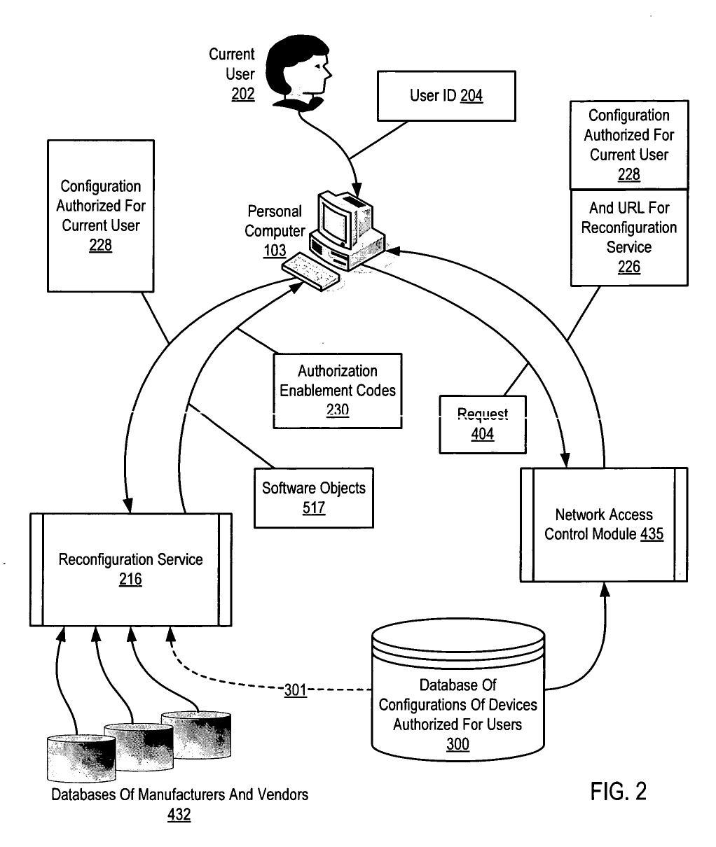

FIG. 2 sets forth a data flow diagram illustrating operation of a further exemplary system for administration of access to computer resources on a network according to embodiments of the present invention. The system of FIG. 2 includes a device communicatively coupled to a network represented here as personal computer (103), a network access control module (435), a reconfiguration service (216), and a database of configurations of devices authorized for users (300). A current user (202) provides user identification (204) to the personal computer (103). The user may provide authentication of his identity to the personal computer (103) in the form of a login and password, a retina scan, fingerprint, RFID tag code, voiceprint, or other methods as will occur to those of skill in the art. Personal computer (103) transmits to the network access control module (435) a request (404) for access to network resources containing an identity of the personal computer (103), an identity of the current user (202) of the personal computer, and the current configuration of the personal computer.

Network access control module (435) retrieves from a database (300) the configuration of the personal computer authorized for the current user and compares the authorized configuration with the current configuration. If the current configuration is not the configuration of the personal computer authorized for the current user, the network access control module transmits to personal computer (103) a URL (226) that provides the network location of the reconfiguration service (216) and the configuration (228) of the device authorized for the current user. In the example of FIG. 2, the personal computer (103) sends the configuration (228) of the personal computer authorized for the current user to reconfiguration service (216) at the URL received from the network access control module.

Reconfiguration service (216) retrieves from storage or creates by calculation authorization enablement codes (230) as needed to reconfigure personal computer (103) to the configuration authorized for the current user and transmits the enablement codes to the communicatively coupled device (103). One or more enablement codes may be needed depending on how many hardware or software elements are to be enabled (or disabled) on personal computer (103). Reconfiguration service (216) may retrieve each such code from a manufacturer's or vendor's on-line database (432) or may calculate the codes in real time according to algorithms provided by manufacturers or vendors of hardware and software present on personal computer (103).

Similarly in response to a request for access redirected to the reconfiguration server, the reconfiguration service (216) may transmit to the requesting device one or more software objects (517) for the configuration of the device authorized for the user. A software object or software component required for an authorized configuration may be missing from the current actual configuration. If so, enabling its use with an enablement code will not suffice; the reconfiguration module usefully then may provide the actual software component itself. It is useful to note in this regard that a software object may not only be an elements of a configuration as such, but a software object may also have an enabling effect on other elements of a configuration, such as, for example, when a supplied software object like a driver actually enables the use of a hardware component that is useless without the driver.

Software objects provided by a reconfiguration service for a configuration of a device authorized for a user may include, for example, application modules or entire software applications, middleware, operating system modules and tools such as the drivers just mentioned, and credentials enabling access to resources—including access to elements of an authorized configuration. Software objects provided by a reconfiguration service for a configuration of a device authorized for a user also may include application content such as, for example, audio files, video clips, text documents, and data files.

The reconfiguration service (216) may receive the configuration of the personal computer (103) authorized for the current user (202) from the personal computer (103) as shown in FIG. 2. Alternatively, as indicated by the dotted arrow (301) between database (300) and reconfiguration service (216), the reconfiguration service (216) may obtain from database (300) a configuration of personal computer (103) authorized for the current user (202). In systems where the reconfiguration service (216) obtains the authorized configuration from a database (300), the network access control module (435) may transmit to the personal computer (103) only the URL (226) of the reconfiguration service (216).

As a further alternative, personal computer (103) may be configured with a network location of a reconfiguration service in non-volatile memory of personal computer (103). In a system so configured, network access control module (435), upon determining that the current configuration is not the configuration of the personal computer authorized for the current user, need only transmit to the personal computer the authorized configuration. The personal computer would already know, in effect, where to find the reconfiguration service, so there would be no need for the response from the network access control module to include the URL (226) of the reconfiguration service. If the reconfiguration service in such a system were configured to obtain the authorized configuration from a database (300), then there would be no need for the network access control module to transmit the authorized configuration to the personal computer. Instead, the response from the network access control module effectively redirecting the request for access to the reconfiguration service may contain only a message to the effect that reconfiguration is needed—including the identity of the device and the identity of the current user.

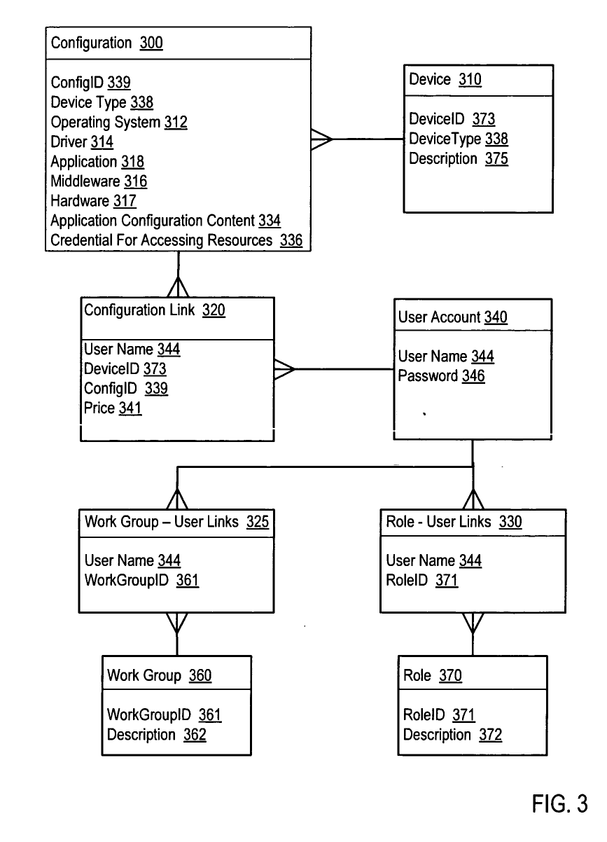

For further explanation, FIG. 3 sets forth a line drawing of exemplary data structures useful in systems for administration of access to computer resources on a network according to embodiments of the present invention. The exemplary data structures of FIG. 3 include a record structure for a configuration (300), each instance of which may be used to represent an authorized configuration of a device for one or more current users. The configuration record (300) of FIG. 3 includes a device type field (338) that may be used to record a type of device, for example, a type of personal computer, laptop, workstation, PDA, or others as will occur to those of skill in the art. The configuration record (300) of FIG. 3 also includes a configuration identity field (339) that identifies a particular configuration.

The configuration record (300) of FIG. 3 includes an operating system field (312) that may be used to identify an operating system operational on a device, such as, for example, UNIX™, Linux™, Microsoft NT™, AIX™, or IBM's i5/OS™. The configuration record (300) of FIG. 3 includes one or more driver fields (314) that may be used to record the device drivers resident on the device. The configuration record (300) of FIG. 3 includes one or more applications fields (318) that may be used to record one or more applications resident on the device. The applications may include word processors, spread sheets, virus protection software, or communications software. The configuration record (300) of FIG. 3 includes one or more middleware fields (316) that may be used to record middleware resident on the device. Middleware is software that functions as a conversion or translation layer. Middleware enables one application to communicate with another that runs on a different platform or is issued from a different vendor. Examples of middleware include Java Messaging Service™ (‘JMS’) and the Common Object Request Broker Architecture (‘CORBA’).

The configuration record (300) of FIG. 3 includes one or more hardware fields (317), that may be used to record hardware enabled on the device. Hardware can include any computer hardware amenable to installation and enablement on a device, including for example, processors, memory, data communications adapters, and non-volatile data stores. The configuration record (300) of FIG. 3 includes one or more application configuration content fields (334), that may be used to record the configuration of applications resident on the device, for example, the most recent update of virus protection software or the configuration of a resident firewall. The configuration record (300) of FIG. 3 includes one or more credentials fields (336), that may be used to record credentials stored on the device. Credentials enable the current user to access resources over a network by authenticating the identity of the user or demonstrating authorization to access a resource. Credentials can include certificates and keys related to public or private key infrastructure, security tokens installed on the device, licenses to use locally installed software, and cached user IDs and passwords.

The exemplary data structures of FIG. 3 include a record structure to represent a device (310). The device record (310) of FIG. 3 includes a device identification field (373), that may be used to record a unique identification for the device. The identification may be immutable. Various systems, such as the IBM Embedded Security System (‘ESS’), are capable of providing devices with unique identifications. For example, the IBM Embedded Security chip, a component of ESS, is in part a smartcard chip which can be placed directly on the motherboard of a device. A unique identification for a device may be stored in an IBM Embedded Security chip installed on the device.

A Media Access Control (‘MAC’) address may also function as device identification. A MAC address is a six-byte identifying number, for example, a1-c2-e3-44-5f-6d, that uniquely identifies nodes on a network, such as personal computers. The communications hardware of the node contains the number. For example, every network adapter, modem, and Ethernet card has a MAC address permanently embedded in the device. Even two identical models from the same manufacturer will have distinct MAC addresses. The MAC address is readable by the network and the operating system of the computer or other processing equipment on which the device is installed.

The device record (310) of FIG. 3 includes a device type field (338), that identifies a type of device, for example, a type of laptop, work station, or PDA. The device record (310) of FIG. 3 includes a description field (375) used to store text describing the device, for example, a name or model number, and so on.

The exemplary data structures of FIG. 3 include a record structure to represent a user account (340). Each user account record represents a user having authorization to access computer resources on a system. The user account record (340) of FIG. 3 includes a user name field (344), that identifies a user such as a current user of a device. The user account record (340) of FIG. 3 includes a password field (346), that may be used to record a password or other credential used to authenticate the user at logon.

The exemplary data structures of FIG. 3 include a record structure to represent a work group (360) of a current user of a device. A work group may be an organization in an enterprise including, for example, administration, sales, technical support, or production. The work group record (360) of FIG. 3 includes a work group identification field (361), that may be used to record a unique identifier for the work group. The identifier may be a name or a number. The work group record (360) of FIG. 3 includes a description field (362), that may be used to record text describing a work group.

The exemplary data structures of FIG. 3 include a record structure to represent a role (370) of a current user of a device. Examples of roles include Help Desk Administrator or Field Sales Representative. The role record (370) of FIG. 3 includes a role identification field (371), that may be used to record a unique identifier for the role. The identifier may be a name or a number. The role record (370) of FIG. 3 includes a description field (372), that may be used to record a description of the role.

The remaining exemplary data structures of FIG. 3 consist of link records, also known as associative or intersection records, which are used to link entities to reconcile a many-to-many relationship between the entities. For example, a many-to-many relationship exists between devices and users. A user may have access to multiple devices, a laptop at home, a PDA while traveling, and a workstation at the office. Similarly, a device may be accessed by multiple users. A workstation of a company that operates in shifts may be used by one person during the day and another at night. A link record between two entities represents a relationship between instances of each entity. An example of such a link record in the exemplary data structures of FIG. 3 is a link record representing a configuration link (320). Each configuration link record (320) represents a configuration of a device authorized for a particular user. The configuration link record (320) of FIG. 3 includes a user name field (344), that may be used to record the name of the current user of a device. The configuration link record (320) of FIG. 3 includes a device identification field (373), that may be used to record the identity of the device.

Some systems of administration of access to network resource according to embodiments of the present invention charge for network access based upon device configuration. In such systems, a configuration of the device authorized for a current user may in fact be a configuration of the device authorized for the current user at a specified price. Data structure support for such systems may be provided by including a price data element such as the one illustrated at reference (341) in FIG. 3. Price field (341) in configuration link record (320) identifies a price, such as, for example, a time unit rate, at which network resources may be accessed by a user (344) from a device (373) having a particular configuration (339).

User name (344) functions as a foreign key implementing a one-to-many relationship between the user accounts (340) and configuration links (320). DeviceID (373) and configID (339) together function as a unique foreign key implementing a one-to-many relationship between the configuration records (300) and the configuration links (320). The configuration link records (320) therefore implement a many-to-many relationship between a user (340) and a configuration of a device (300).

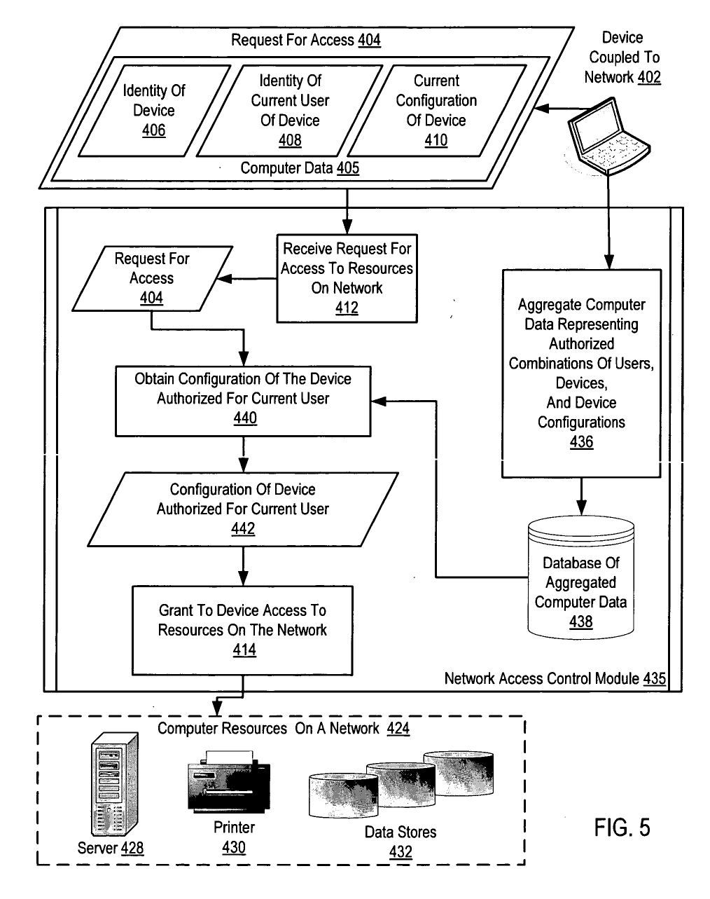

Note that the contents of the configuration link are the data elements in a request for access to computer resources (reference 404 on FIG. 5), identification of a current user (344), identity of a configuration (339), and a device identification (373). Determining whether a current configuration of a device is authorized for a current user then may be carried out in some embodiments at least by a network access control module's looking up a record in a configuration link table. If a record exists having the same configuration ID, user ID, and device ID as in the request for access, then the current configuration of the device is the same as an authorized configuration.

The exemplary data structures of FIG. 3 include a link record structure to represent a role-user link (330) that implements a many-to-many relationship between roles (370) and users (340). Multiple users may fill the same role. For example, a department may employ many sales representatives. Similarly, a user may fill multiple roles. A user may function as both a manager and a sales representative. The role-user link record (330) of FIG. 3 includes a user name field (344), that may be used to record the name of a current user of a device. The role-user link record (330) of FIG. 3 includes a role identification field (371), that may be used to record an identification of a role, such as a name or a number.

The exemplary data structures of FIG. 3 include a link record structure to represent a work group-user link (325) that implements a many-to-many relationship between work groups (360) and users (340). Multiple users may belong to the same work group. For example, many users may work for a particular department. Similarly, a user may belong to multiple work groups. A user may belong to a sales work group and a management work group. The work group-user link record (325) of FIG. 3 includes a user name field (344), that may be used to record the name of a user of a device. The work group-user link record (325) of FIG. 3 includes a work group identification field (361), that may be used to record an identification of a work group, such as a name or a number.

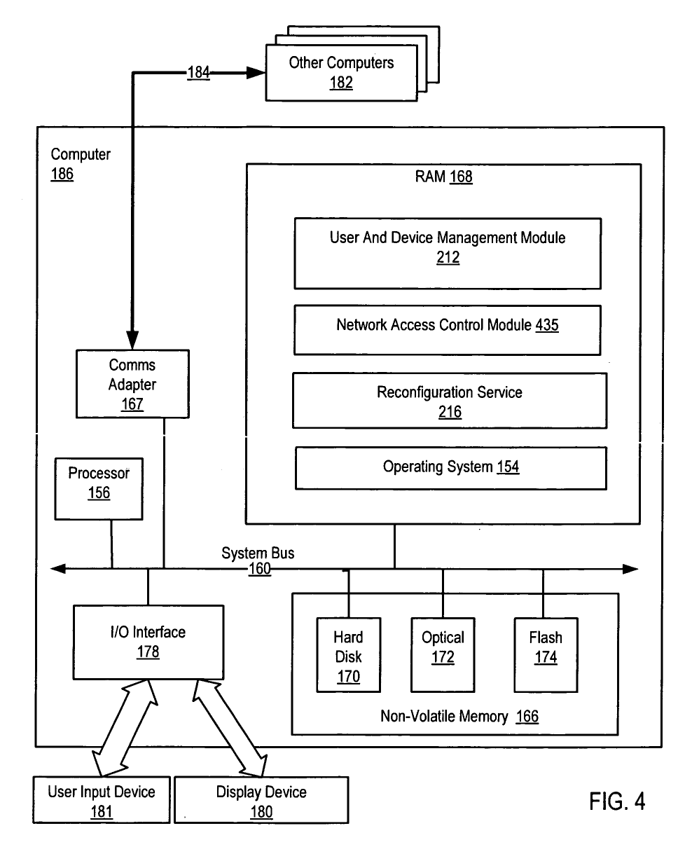

Administration of access to computer resources on a network in accordance with the present invention is generally implemented with computers, that is, with automated computing machinery. In the system of FIG. 1, for example, all the servers, resources, and other devices are implemented to some extent at least as computers. For further explanation, therefore, FIG. 4 sets forth a block diagram of automated computing machinery comprising an exemplary computer (186) useful in administration of access to computer resources on a network according to embodiments of the present invention. The computer (186) of FIG. 4 includes at least one computer processor (156) or ‘CPU’ as well as random access memory (168) (“RAM”) which is connected through a system bus (160) to processor (156) and to other components of the computer.

Stored in RAM (168) is a user and device management module (212), computer program instructions for registering users and computing devices and verifying the registration of a user and a computing device when the user on the computing device seeks access to network resources. Also stored in RAM (168) is a network access control module (435), a set of computer program instructions improved for administration of access to computer resources on a network according to embodiments of the present invention. The computer program instructions of the network access control module (435) include instructions for receiving, from a device communicatively coupled to a network, a request for access to resources on the network, the request including computer data representing an identity of the device, an identity of a current user of the device, and a current configuration of the device. The network access control module (435) also include instructions for granting to the device access to resources on the network in dependence upon the identity of the device, the identity of the current user, the current configuration of the device, and a configuration of the device authorized for the current user.

Also stored in RAM (168) is a reconfiguration service (216), improved for administration of access to computer resources on a network according to embodiments of the present invention. The computer program instructions of the reconfiguration service (216) include a set of computer program instructions for communicating with a device communicatively coupled to a network, for receiving a configuration of a device authorized for the current user of the device, and for transmitting to the device authorization enablement codes for the configuration of the device authorized for the current user.

Also stored in RAM (168) is an operating system (154). Operating systems useful in computers according to embodiments of the present invention include UNIX™, Linux™, Microsoft NT™, AIX™, IBM's i5/OS™, and others as will occur to those of skill in the art. Operating system (154), user and device management module (212), network access control module (435), and reconfiguration service (216) in the example of FIG. 4 are shown in RAM (168), but many components of such software typically are stored in non-volatile memory (166) also.

Computer (186) of FIG. 4 includes non-volatile computer memory (166) coupled through a system bus (160) to processor (156) and to other components of the computer (186). Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The example computer of FIG. 4 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

The exemplary computer (186) of FIG. 4 includes a communications adapter (167) for implementing data communications (184) with other computers (182). The other computers (182) may include devices communicatively coupled to a network which request access to resources on the network. Such data communications may be carried out through serially through RS-232 connections, through external buses such as USB, through data communications networks such as IP networks, and in other ways as will occur to those of skill in the art. Communications adapters implement the hardware level of data communications through which one computer sends data communications to another computer, directly or through a network. Examples of communications adapters useful for administration of access to computer resources on a network according to embodiments of the present invention include modems for wired dial-up communications, Ethernet (IEEE 802.3) adapters for wired network communications, and 802.11b adapters for wireless network communications.

For further explanation, FIG. 5 sets forth a flow chart illustrating an exemplary method for administration of access to computer resources on a network according to embodiments of the present invention that includes receiving (412) in a network access control module (435) on a network (reference 100 on FIG. 1), from a device (402) communicatively coupled to the network, a request (404) for access to resources on the network. In the example of FIG. 5, the request (404) includes computer data (405) representing an identity of the device (406), an identity of a current user of the device (408), and a current configuration (410) of the device.

In the example of FIG. 5, the request (404) may be in the form of a logon message from the device (402) to the network access control module (435). Receiving (412) the request (404) for access to resources on the network may be carried out as part of receiving and processing a logon message from the device (402) to the network access control module (435). For example, when a computer running Windows NT and communicatively connected to a network issues a login request, a service installed and operational on the computer may establish a communications link between the computer and a domain server and pass on the logon request. A domain controller, represented here by network access control module (435), installed on the domain server receives and processes the logon message. A request for access to computer resources also may be implemented as a request to create a symbolic link to a resource, that is, map a shared network resource, such as, for example, a shared file system or disk drive, to a device coupled to the network. In addition, requests for access to resources on the network may be implemented in other ways as will occur to those of skill in the art, and all such ways are well within the scope of the present application.

The request (404) includes computer data (405) representing an identity of the device (406), an identity of a current user of the device (408), and a current configuration (410) of the device. An identity of a device may be a unique device identity for the device, such as an identification number on an IBM Embedded Security chip or a MAC address. An identity of a current user of the device may be a user name or a user identification number. A current configuration (410) of the device is a description of the software, hardware, and credentials presently enabled for operation on the device. Software configurable on the device may include software applications installed on the device as well as operating systems and their patches, service packs, hot fixes, and other modifications to operating systems. The software configurable on the device can also include drivers and middleware. The configuration content for applications can include firewall policies, virus definition files, data communications protocols, and other data on the configuration of applications. Hardware configurable on the device can include any computer hardware amenable to installation and enablement on a device, such as for example, processors, memory, data communications adapters, and non-volatile data stores. Credentials enable the current user to access resources over a network by authenticating the identity of the current user or demonstrating authorization to access a resource. Credentials configurable on the device can include certificates and keys related to public or private key infrastructure, security tokens installed on the device, licenses to use locally installed software, and cached user IDs and passwords.

The method of FIG. 5 further includes aggregating (436) computer data representing authorized combinations of users, devices, and device configurations. Aggregating computer data representing authorized combinations of users, devices, and device configurations may be carried out by registering users in a user registry or directory, registering devices in a device registry or directory, establishing authorized combinations of users, devices, and device configurations, and storing data describing the registered users and devices and the authorized combinations in a database (438) of aggregated computer data containing records representing authorized combinations of users, devices, and device configurations such as the records illustrated in FIG. 3. Registering a user may include creating a record in database (438) containing information about the user, such as the user name and password, and by creating link records to the user's work groups, roles, and device configurations. Registering a device may include creating a record in database (438) containing information about the device, such as a unique identification number, the device type, and description, and by creating link records to device configurations. An authorized combination may be established, for example, according to the role of the user, a group attribute of a user, or in other ways as will occur to those of skill in the art. Such authorized configurations may be represented by configuration records such as the ones illustrated at reference 300 in FIG. 3.

The method of FIG. 5 also includes obtaining (440) the configuration of the device authorized for the current user (442). Obtaining (440) the configuration of the device authorized for the current user (442) may be carried out by querying database (438) of aggregated computer data representing authorized combinations of users, devices, and device configurations. In the example of FIG. 3, data representing an authorized configuration for a user and a device is recorded on a configuration link record (320).

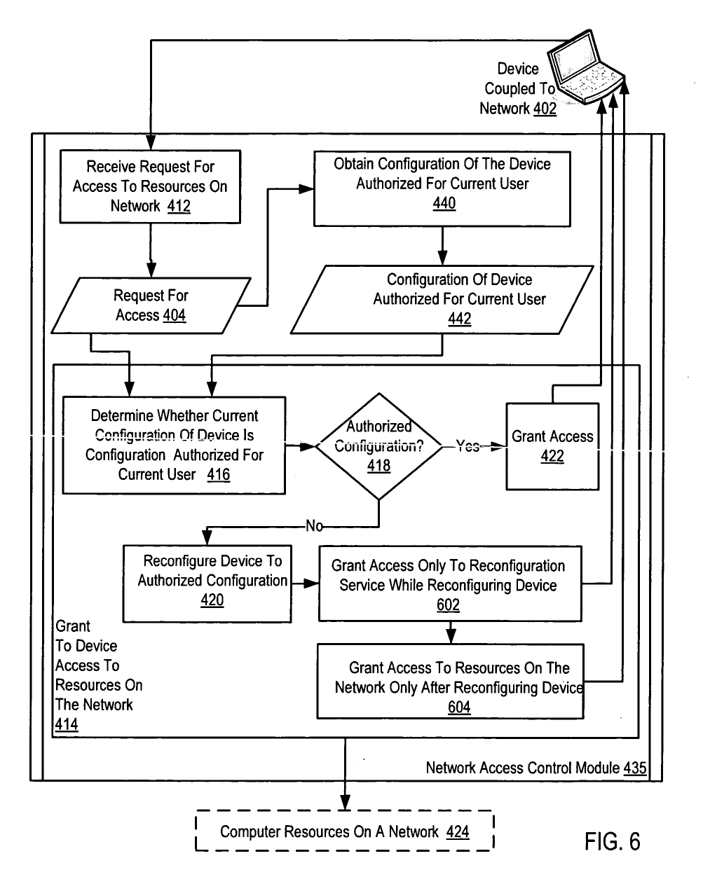

The method of FIG. 5 includes granting (414), by the network access control module (435) to the device (402), access to resources (424) on a network in dependence upon the identity of the device (406), the identity of the current user (408), the current configuration (410), of the device, and a configuration (442) of the device authorized for the current user. For further explanation, FIG. 6 sets forth a flow chart illustrating an exemplary method of granting (414) access to resources (424) on a network according to embodiments of the present invention. In the method of FIG. 6, granting (414) access to resources on the network includes determining (416) whether the current configuration of the device is the configuration of the device authorized for the current user. Determining (416) whether the current configuration of the device is the configuration of the device authorized for the current user can be carried out by comparing the current configuration from the request for access (404) with the configuration (442) of the device authorized for the current user. If the current configuration of the device is a configuration of the device authorized for the current user, the method of FIG. 6 includes granting (422) access to resources on the network to the device (402) coupled to the network. When the request for resources is in the form of a log-in message, for example, granting access to the device (402) coupled to the network can be carried out by the network access control module's logging the device onto the network and authorizing the device to access one or more network resources (424).

If the current configuration of the device is not a configuration of the device authorized for the current user, granting to a device access to resources on the network in the method of FIG. 6 includes reconfiguring (420) the device (402) to the configuration (442) of the device authorized for the current user. Reconfiguring (420) the device (402) to the configuration (442) of the device authorized for the current user may be carried out obtaining an authorization enablement code for reconfiguring the device to the configuration (442) of the device authorized for the current user and sending the enablement code to the device. Obtaining an authorization enablement code for reconfiguring the device may be carried out by sending to a reconfiguration service data representing the configuration (442) of the device authorized for the current user and receiving from the reconfiguration service an authorization enablement code for reconfiguring the device.

In the method of FIG. 6, granting access (414) to resources on the network further includes granting access (602) only to the reconfiguration service while reconfiguring the device. In many systems for administration of access to computer resources on a network according to embodiments of the present invention, a reconfiguration service is itself a resource on the network. In such systems, redirecting a request for access to a reconfiguration service may involve granting a limited access to computer resources on the network, limited, that is, to accessing only the reconfiguration service at, for example, a designated URL. Such limited access may be implemented in a number of ways. A network access control module may, for example, establish a temporary virtual LAN composed of only two hosts, the requesting device and the machine on which the reconfiguration service is installed. In this case, packets from the requesting device may be circulated on the network, but only to and from the reconfiguration service. Alternatively, granting access (602) only to the reconfiguration service while reconfiguring the device may be carried out by creating a temporary set of network access authorizations that authorizes only a single network resource for access by the current user of a device coupled to the network, that is, access only to the reconfiguration service.

In the method of FIG. 5, granting access (414) to resources on the network further includes granting access to resources on the network only after reconfiguring the device (604). After a device receives new authorization enablement codes from the reconfiguration service and applies the codes to reconfigure the hardware and software on the device to the configuration authorized for the current user, the current configuration of the device and the authorized configuration of the device are the same. The coupled device may again transmit a request for access to network resources that includes a device ID, user ID, and current configuration of the device. The current configuration of the device now matches the authorized configuration, and a network access control module will grant the requested access.

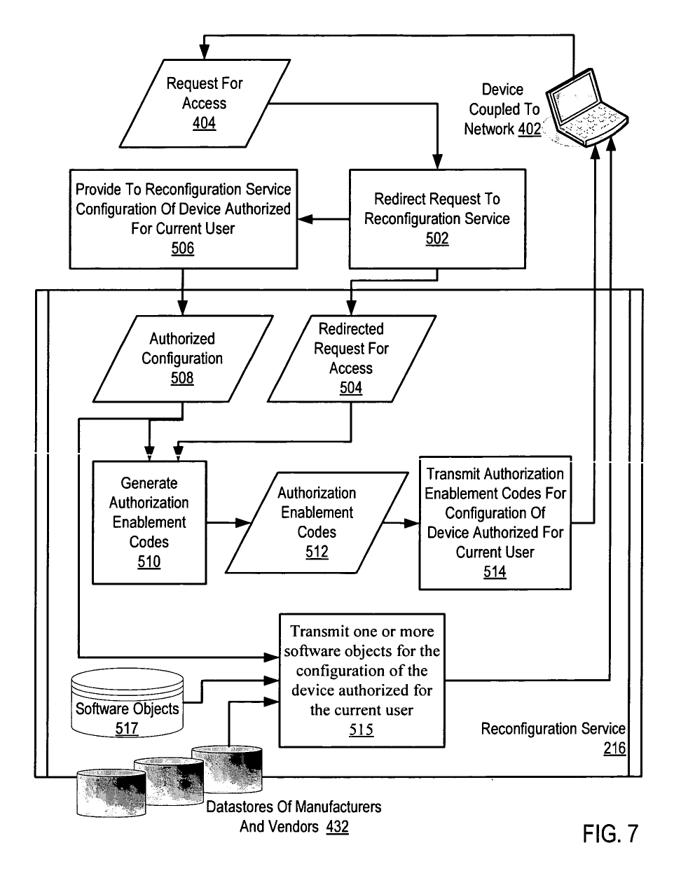

For further explanation, FIG. 7 sets forth a flow chart illustrating an exemplary method for reconfiguring a device to a configuration of the device authorized for a current user according to embodiments of the present invention. In the method of FIG. 7, reconfiguring the device includes redirecting (502) a request for access to resources on a network to a reconfiguration service (216). Redirecting (502) the request to a reconfiguration service (216) may be carried out, for example, by sending from a network access control module to a device (402) communicatively coupled to the network a URL specifying the network address of a reconfiguration service. The device (402) communicatively coupled to the network may send the redirected request (504) for access to the reconfiguration service (216) at the URL specifying the reconfiguration service's network address.

In the method of FIG. 7, reconfiguring the device further includes providing (506) to the reconfiguration service (216) the configuration (508) of the device authorized for the current user. Providing (506) to the reconfiguration service (216) the configuration (508) of the device authorized for the current user may be carried out by the network access control module's obtaining from a database (300 on FIG. 2) of authorized configurations of devices for users an authorized configuration of the device for the current user, providing the authorized configuration of the device for the user to the device (402) communicatively coupled to the network, and transmitting from the device (402) to a reconfiguration service (216) the configuration (508) of the device authorized for the current user. The database of authorized configurations of devices for users may be implemented with records of configurations and of links between users, devices, and configurations similar to those illustrated in FIG. 3. Alternatively, providing (506) to the reconfiguration service the configuration (508) of the device authorized for the current user may be carried out by providing the configuration (508) of the device authorized for the current user to the reconfiguration service (216) directly from the database as illustrated by the dotted line between the reconfiguration service and the database in FIG. 2.

The method of FIG. 7 includes generating (510) authorization enablement codes for the configuration of the device authorized for a current user. Reconfiguration service (216) may generate authorization enablement codes by retrieving codes from storage or by calculating authorization enablement codes as needed to reconfigure personal computer (103 on FIG. 1) to the configuration authorized for the current user. One or more enablement codes may be needed depending on how many hardware or software elements are to be enabled on personal computer (103 on FIG. 1). Reconfiguration service (216) may retrieve each such code from a manufacturer's or vendor's on-line database (432) or may calculate the codes in real time according to algorithms provided by manufacturers or vendors of hardware and software present on device (402).

The method of FIG. 7 also includes transmitting (514), from the reconfiguration service (216) to the device (402), authorization enablement codes (512) for the configuration (508) of the device authorized for the current user. Transmitting the authorization enablement code may be carried out by transmission via network (100 on FIG. 1).

Similarly in response to a request for access redirected to the reconfiguration server, in the method of FIG. 7 reconfiguring the device may include transmitting (515), from a reconfiguration service (216) to the device (402), one or more software objects (517) for the configuration of the device authorized for the current user. A software object or software component required for an authorized configuration may be missing from the current actual configuration. If so, enabling its use with an enablement code will not suffice; the reconfiguration module usefully then may provide the actual software component itself. It is useful to note in this regard that a software object may not only be an elements of a configuration as such, but a software object may also have an enabling effect on other elements of a configuration, such as, for example, when a supplied software object like a driver actually enables the use of a hardware component that is useless without the driver.

Software objects provided by a reconfiguration service for a configuration of a device authorized for a user may include, for example, application modules or entire software applications, middleware, operating system modules and tools such as the drivers just mentioned, and credentials enabling access to resources—including access to elements of an authorized configuration. Software objects provided by a reconfiguration service for a configuration of a device authorized for a user also may include application content such as, for example, audio files, video clips, text documents, and data files. Software objects may be retrieved for transmittal from a local data store (517) maintained by or on behalf of the reconfiguration service (216). Software objects may be obtained for transmittal from data stores of software manufacturers or developers (432). Or software objects may be obtained for transmittal in other ways as will occur to those of skill in the art, all such ways being well within the scope of the present invention.

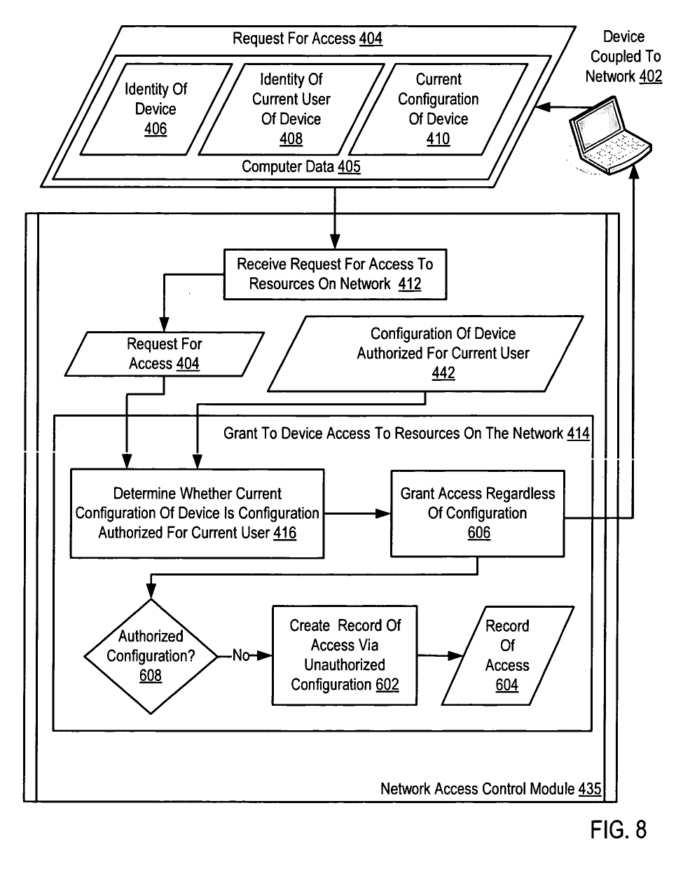

For further explanation, FIG. 8 sets forth a flow chart illustrating a further exemplary method for administration of access to computer resources on a network according to embodiments of the present invention. The exemplary method of FIG. 8 is similar to the method of FIG. 5. That is, the method of FIG. 8 includes receiving (412) in a network access control module (435) on a network, from a device (402) communicatively coupled to the network, a request (404) for access to resources on the network. In the example of FIG. 8, the request (404) includes computer data (405) representing an identity of the device (406), an identity of a current user of the device (408), and a current configuration (410) of the device. The method of FIG. 8 also includes granting (414), by the network access control module (435) to the device (402), access to resources (424) on the network in dependence upon the identity of the device (406), the identity of the current user (408), the current configuration of the device (410), and a configuration (442) of the device authorized for the current user.

In the method of FIG. 8, however, granting access to resources on the network further includes determining (416) whether the current configuration of the device is the configuration of the device authorized for the current user (442). Determining (416) whether the current configuration of the device is the configuration of the device authorized for the current user can be carried out by obtaining a configuration (442) of the device authorized for the current user and comparing the authorized configuration with the current configuration. Obtaining a configuration (442) of the device authorized for the current user may be carried out by querying a database which aggregates computer data representing authorized combinations of users, devices, and device configurations. In the example of FIG. 3, a configuration link record (320) contains a field recording an authorized configuration for a user and a device. Computer data representing the current configuration (410) of the device is contained in the request (404) for access to network resources.

The method of FIG. 8 also includes granting access to network resources regardless (606) whether the current configuration of the device is the configuration of the device authorized for the current user. Granting access to network resources regardless (606) whether the current configuration of the device is the configuration of the device authorized for the current user can be carried out by providing the device (402) communicatively coupled to the network with full network access privileges according to authorizations for the current user without regard to device configuration.

If the current configuration of the device is not the configuration of the device authorized for the current user, the method of FIG. 8 also includes creating (602) a record of access (604) to network resources by a current user through a device having a current configuration of the device that is not the configuration of the device authorized for the current user. The network access control module (435) can send a copy of the record to the current user, to inform the user of the improper configuration. The network access control module (435) can send a copy of the record to a system administrator, to inform the administrator of the improper configuration. In systems where a charge for network access is based upon device configuration, the system administrator can utilize such records of access to network resources to calculate charges for usage according to user identity and device configuration.

It is apparent to readers of skill in the art in view of the preceding explanation that the advantages of practicing administration of access to computer resources on a network according to embodiments of the present invention include reconfiguring a user's device on the fly, in near real time, to a healthy, authorized configuration for the user, a configuration that meets enterprise security and update policies for healthy hardware and software, a configuration that is authorized for the user according to enterprise licensing rules, a configuration that is cost-effective for the user's work role, tailored according to enterprise plans for license costs.

### Use Case

Introduction: The following exemplary use case is presented for further explanation. The use case as presented includes descriptions of sequences of events and data flows used in this example to administer access to computer resources on a network according to embodiments of the present invention.

The use case: A network access control module is installed on the company intranet. A reconfiguration module is deployed on the company intranet and prepared to effect reconfiguration of devices as needed. Company intranet access is controlled by Login/Password and PKI-based authentication.

New User A is hired by company to work as a field sales representative. Company intends to assign Laptop X to new user A. Laptop X will be used to access a company intranet from remote locations.

Laptop X is unpacked from factory by IT staff and registered as a device in the asset management system. A device ID is registered as well as a device profile. Laptop X is configured as it arrived from the factory, having no relation to any authorized configuration for any user. Laptop X is installed with a network client capable of interacting with a network access control module and a reconfiguration service according to embodiments of the present invention. Laptop X is marked available in the asset management system. Device profiles from the asset management system are aggregated into the Company's identity management system so that Laptop X is known as available in both the asset management system and the identity management system.

User A is registered with Company's identity management system. User A's identity information is added to the identity management system. User A is assigned the FieldSalesRep role in the identity management system. Based on the FieldSalesRep role of User A, User A is assigned a laptop and an authorized configuration of the laptop. Laptop X is assigned to User A. The assignment is represented by aggregating from the asset management system and the identify management system into a combined data structure computer data representing the authorized combination of User A, Laptop X, and a configuration of Laptop X authorized for User A.

As a result, a combined device identity and user identity is now registered with the identity management system. A network access control module in the company intranet can now administer access to network resources keyed against both the user identity and the device identity. With this combined device and user identity, the enterprise can leverage all functions of existing systems with a finer level of granularity in integrated solutions.

User A is given Laptop X. User A attempts to access the company intranet using Laptop X. The network client on Laptop X prompts User A for identity and password and transmits the user identity, the user password, and the current configuration of Laptop X to a network access control module in the form of a request for access to network resources, in this example, a logon to the network. Laptop X's current configuration is still as it arrived from the factory, not the authorized configuration for User A.

The network access control module compares the current configuration to the authorized configuration for User A. The network access control module does not allow device to access company intranet because the device is in the wrong state for the current user. Instead, the network access control module redirects User A's request for access to a reconfiguration service, passing the authorized configuration as parameter data. The reconfiguration module updates laptop X with new software, software updates, user credentials, hardware usage authorizations, and so on, according to the authorized configuration of Laptop X for User A. Data describing the current configuration of Laptop X is updated on the laptop. Laptop X again transmits to the network access control module User A's identity and password and data describing its current configuration—which is now the laptop's authorized configuration for User A. Now the network access control module grants to User A and Laptop X access to network resources. The detection of the unauthorized configuration, redirection to the reconfiguration service, and the eventual grant of access all occurred with little or no perceptible delay in User A's logon.

User A's employment with Company is terminated, and Laptop X is returned to Company's asset management department. Laptop X is marked available in the asset management system. Device profiles from the asset management system are aggregated into the identity management system so that Laptop X is known as available in both the asset management system and the identity management system. User B, a Help Desk Administrator, is registered with an identity and password in the identity management system. User B is assigned the HelpDeskRep role in the identity management system. Based on the HelpDeskRep role of User B, User B is assigned a laptop. Laptop X is assigned to User B by the identity management system. A combined device identity and user identity are registered with the identity management system. A combined user identity, device identity, and authorized configuration of the device for User B are aggregated and made available to the network access control module. Laptop X will now be used to access an internal customer relations management (‘CRM’) system using login/password and token-based access control.

User B is given Laptop X and attempt to access the Help Desk Website with Laptop X. The network client on Laptop X prompts User B for identity and password and transmits the user identity, the user password, and the current configuration of Laptop X to the network access control module in the form of a request for access to network resources, in this example, access to the Help Desk Website. Laptop X's current configuration is still as it was configured for User A, a different configuration than that authorized for User B.

The network access control module compares the current configuration to the authorized configuration for User B. The network access control module does not allow the device to access company intranet or the Help Desk Website because the device is in the wrong state for the current user. Instead, the network access control module redirects User B's request for access to a reconfiguration service, passing the authorized configuration as parameter data. The reconfiguration module updates laptop X with new software, software updates, user credentials, hardware usage authorizations, and so on, according to the authorized configuration of Laptop X for User B. Data describing the current configuration of Laptop X is updated on the laptop. Laptop X again transmits to the network access control module User B's identity and password and data describing the laptop's current configuration—which is now its authorized configuration for User B. Now the network access control module grants to User B and Laptop X access to network resources, in this example, the Help Desk Website. Again, the detection of the unauthorized configuration, redirection to the reconfiguration service, and the eventual grant of access all occurred with little or no perceptible delay in User B's access of the Help Desk Website.

Exemplary embodiments of the present invention are described largely in the context of a fully functional computer system for administration of access to computer resources on a network. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for administration of access to computer resources on a network, the method comprising:
receiving in a network access control module on a network, from a device communicatively coupled to the network, a request for access to resources on the network, the request including computer data representing an identity of the device, an identity of a current user of the device, and a current configuration of the device; and
granting, by the network access control module to the device, access to resources on the network in dependence upon the identity of the device, the identity of the current user, the current configuration of the device, and a configuration of the device authorized for the current user.

2. The method of claim 1 further comprising aggregating computer data representing authorized combinations of users, devices, and device configurations.

3. The method of claim 1 wherein granting access to resources on the network further comprises:
determining whether the current configuration of the device is the configuration of the device authorized for the current user; and
if the current configuration of the device is not the configuration of the device authorized for the current user, reconfiguring the device to the configuration of the device authorized for the current user.

4. The method of claim 3 wherein reconfiguring the device further comprises:
redirecting the request to a reconfiguration service;
providing to the reconfiguration service the configuration of the device authorized for the current user; and
transmitting, from the reconfiguration service to the device, authorization enablement codes for the configuration of the device authorized for the current user.

5. The method of claim 3 wherein reconfiguring the device further comprises transmitting, from a reconfiguration service to the device, one or more software objects for the configuration of the device authorized for the current user.

6. The method of claim 3 wherein granting access to resources on the network further comprises granting access only to the reconfiguration service while reconfiguring the device.

7. The method of claim 3 wherein granting access to resources on the network further comprises granting access to resources on the network only after reconfiguring the device.

8. The method of claim 1 wherein granting access to resources on the network further comprises:
determining whether the current configuration of the device is the configuration of the device authorized for the current user;
granting access to network resources regardless whether the current configuration of the device is the configuration of the device authorized for the current user; and
if the current configuration of the device is not the configuration of the device authorized for the current user, creating a record of access to network resources by a current user through a device having a current configuration of the device that is not the configuration of the device authorized for the current user.

9. A system for administration of access to computer resources on a network, the system comprising a computer processor, a computer memory operatively coupled to the computer processor, the computer memory having disposed within it computer program instructions capable of:
receiving in a network access control module on a network, from a device communicatively coupled to the network, a request for access to resources on the network, the request including computer data representing an identity of the device, an identity of a current user of the device, and a current configuration of the device; and
granting, by the network access control module to the device, access to resources on the network in dependence upon the identity of the device, the identity of the current user, the current configuration of the device, and a configuration of the device authorized for the current user.

10. The system of claim 9 wherein granting access to resources on the network further comprises:
determining whether the current configuration of the device is the configuration of the device authorized for the current user; and
if the current configuration of the device is not the configuration of the device authorized for the current user, reconfiguring the device to the configuration of the device authorized for the current user.

11. The system of claim 10 wherein reconfiguring the device further comprises:
redirecting the request to a reconfiguration service;
providing to the reconfiguration service the configuration of the device authorized for the current user; and
transmitting, from the reconfiguration service to the device, authorization enablement codes for the configuration of the device authorized for the current user.

12. The system of claim 10 wherein granting access to resources on the network further comprises granting access to resources on the network only after reconfiguring the device.

13. The system of claim 9 wherein granting access to resources on the network further comprises:
determining whether the current configuration of the device is the configuration of the device authorized for the current user;
granting access to network resources regardless whether the current configuration of the device is the configuration of the device authorized for the current user; and
if the current configuration of the device is not the configuration of the device authorized for the current user, creating a record of access to network resources by a current user through a device having a current configuration of the device that is not the configuration of the device authorized for the current user.

14. A computer program product for administration of access to computer resources on a network, the computer program product disposed upon a signal bearing medium, the computer program product comprising computer program instructions capable of:
receiving in a network access control module on a network, from a device communicatively coupled to the network, a request for access to resources on the network, the request including computer data representing an identity of the device, an identity of a current user of the device, and a current configuration of the device; and
granting, by the network access control module to the device, access to resources on the network in dependence upon the identity of the device, the identity of the current user, the current configuration of the device, and a configuration of the device authorized for the current user.

15. The computer program product of claim 14 wherein the signal bearing medium comprises a recordable medium.

16. The computer program product of claim 14 wherein the signal bearing medium comprises a transmission medium.

17. The computer program product of claim 14 wherein granting access to resources on the network further comprises:
determining whether the current configuration of the device is the configuration of the device authorized for the current user; and
if the current configuration of the device is not the configuration of the device authorized for the current user, reconfiguring the device to the configuration of the device authorized for the current user.

18. The computer program product of claim 17 wherein reconfiguring the device further comprises:
redirecting the request to a reconfiguration service;
providing to the reconfiguration service the configuration of the device authorized for the current user; and
transmitting, from the reconfiguration service to the device, authorization enablement codes for the configuration of the device authorized for the current user.

19. The computer program product of claim 17 wherein granting access to resources on the network further comprises granting access only to the reconfiguration service while reconfiguring the device.

20. The computer program product of claim 14 wherein granting access to resources on the network further comprises:
determining whether the current configuration of the device is the configuration of the device authorized for the current user;
granting access to network resources regardless whether the current configuration of the device is the configuration of the device authorized for the current user; and
if the current configuration of the device is not the configuration of the device authorized for the current user, creating a record of access to network resources by a current user through a device having a current configuration of the device that is not the configuration of the device authorized for the current user.
